(19) United States
(12) Patent Application Publication
(10) Pub. No.: US 2019/0345322 A1
(43) Pub. Date: Nov. 14, 2019

(54) ELASTOMERIC THERMOPLASTIC PRE-EXPANSION COMPOSITION COMPRISING AN ELASTOMER AND A PHYSICAL BLOWING AGENT

(71) Applicant: MCPP INNOVATION LLC, Tokyo (JP)

(72) Inventors: Jérémy Bardin, Tiffauges (FR); Christophe Auriant, Tiffauges (FR)

(73) Assignee: MCPP INNOVATION LLC, Tokyo (JP)

(21) Appl. No.: 16/216,900

(22) Filed: Dec. 11, 2018

(30) Foreign Application Priority Data
Dec. 12, 2017 (FR) 1762001

(51) Int. Cl. C08L 53/02; C08L 91/00; C08J 9/00; C08J 9/232; B29C 44/34

(52) U.S. Cl. CPC C08L 53/02; B29K 2096/04; C08J 9/0061; C08J 9/232; B29C 44/3461; C08L 2205/035; C08L 2205/025; C08L 2203/14; C08L 2207/322; C08L 2205/06; C08J 2203/22; C08J 2391/00; C08J 2353/02; C08J 2453/02; C08J 2423/06; C08J 2423/12; C08J 2471/12; C08L 91/00

(57) ABSTRACT

A subject matter of the invention is a pre-expansion thermoplastic elastomeric composition comprising at least 10% by weight of one or more elastomers and heat-expandable polymeric particles encapsulating a heat-expandable fluid.

Another subject matter of the invention is a process for the preparation of an expanded thermoplastic elastomeric composition comprising the following stages:

injection into a mold or addition to an extruder die of the pre-expansion elastomeric composition according to the invention, then

heating the pre-expansion elastomeric composition at a temperature greater than the temperature for expansion of the heat-expandable polymeric particles, preferably of greater than 160° C.

A subject matter of the invention is also an expanded thermoplastic elastomeric composition capable of being obtained by the process.

Finally, a subject matter of the invention is a sealing lip used in the fields of the transportation industry and in the construction industry.

A subject matter of the present invention is a noncrosslinked pre-expansion thermoplastic elastomeric composition comprising at least 10% by weight of one or more multiblock elastomers comprising at least one soft block and at least one hard block, and heat-expandable polymeric particles.

Another subject matter of the invention is a process for the preparation of the expanded elastomeric composition according to the invention.

A subject matter of the invention is also a noncrosslinked expanded thermoplastic elastomeric composition capable of being obtained by the process according to the invention.

Finally, a subject matter of the invention is also a sealing lip which can be used in various fields requiring sealing properties.

In the motor vehicle field, the general trend is toward the lightening of vehicles in order to reduce the fuel consumption of the vehicles but also toward reducing the unit cost of vehicles by decreasing the amount of materials necessary for their manufacture.

The plastic parts of a vehicle, in particular seals, do not escape this trend.

This trend toward the lightening of plastic parts is also true in the fields of construction, electrical goods or even packaging.

The main technique for reducing the density of a plastic material while keeping its dimensions intact consists in expanding said material.

To do this, a person skilled in the art has available mainly two techniques: the injection of gas directly into the line for extrusion/injection of the material and the use of chemical or physical expanding agents, in the masterbatch form, that is to say in addition separate from the main composition.

There are numerous disadvantages to the first technique (injection of gas): it requires expensive equipment and great expertise in the implementation.

Neither is the second technique in any way perfect in the sense that it requires a second metering device, which is a rather rare item of equipment with equipment manufacturers. In addition, the fact of having to manage a precise dosage of the masterbatch results, in terms of quality, in a degree of dispersity in the final density of the parts produced.

More explicitly, chemical expanding agents are chemical compounds which, under the effect of heat, decompose and produce gas, generally molecular nitrogen or carbon dioxide.

Physical expanding agents generally consist of hollow polymeric particles filled with a heat-expandable fluid.

During the preparation of the plastic material, which consists in heating the elastomeric matrix, the physical expansion polymeric particles swell under the effect of the increase in the pressure due to the expansion of the fluid until a certain size is reached, thus forming the porosity of the expanded elastomeric composition.

A specific application of the seals relates to seals for windows, doors or trunks and more particularly the part known as sealing “lip”, which brings the window, door or trunk into contact with the remainder of the structure.

The sealing lip has to exhibit specific characteristics. More specifically, it has to exhibit the lowest possible compression set in order to provide the best possible sealing between the window, the door or the trunk and the remainder of the structure.

Conventionally, in the context of formulations comprising multiblock elastomers, one way of obtaining low compression sets is to crosslink these elastomers (in particular via peroxides), which unfortunately often tends to damage the emission properties by generation of volatile organic compounds (VOCs).

Nevertheless, in the context of the development of vehicles which are friendly to the environment and to users, the search for materials which are weak emitters of volatile organic compounds is a priority. Thus, a new vehicle (and thus the materials of which it is composed) has to emit a minimum amount of volatile organic compounds.

Thus, the technical problem of the invention is to provide a novel pre-expanded thermoplastic elastomeric material which makes it possible to obtain in particular an expanded sealing lip exhibiting good elastomeric properties similar to, indeed even better than, those of a nonexpanded sealing lip, in particular regarding the compression set, also preferably exhibiting the lowest possible release of volatile organic compounds, and which can be employed using standard and simple extrusion or injection processes (without injection of gas, liquid or other masterbatch).

A noncrosslinked pre-expanded thermoplastic elastomeric material comprising at least 10% by weight of one or more multiblock elastomers comprising at least one soft block and at least one hard block, and heat-expandable polymeric particles, has now been discovered which exhibits the required characteristics.

Thus, a subject matter of the present invention is a noncrosslinked pre-expansion thermoplastic elastomeric composition, comprising:

at least 10% by weight, with respect to the total weight of the composition, of one or more multiblock elastomers comprising at least one soft block and at least one hard block,

heat-expandable polymeric particles encapsulating a heat-expandable fluid.

The pre-expansion thermoplastic elastomeric composition according to the invention makes it possible to obtain an expanded elastomeric composition exhibiting good elastomeric properties, in particular a compression set which is similar to, indeed even better than, those of a nonexpanded equivalent product. Furthermore, the expanded thermoplastic elastomeric composition exhibits a low emission of volatile organic compounds. In addition, it makes it possible to be employed by standard and simple extrusion or injection processes.

Another subject matter of the invention is a process for the preparation of an expanded elastomeric composition comprising the following stages:

injection into a mold or addition to an extruder die of the pre-expansion elastomeric composition as defined above, then

heating the composition at a temperature greater than the temperature for expansion of the heat-expandable polymeric particles, preferably of greater than 160° C.

A subject matter of the invention is also a noncrosslinked expanded thermoplastic elastomeric composition capable of being obtained by the above process.

Finally, a subject matter of the invention is also a sealing lip which can be used in various fields requiring sealing properties, such as the industry of transportation, construction, electrical goods or even packaging.

Other subject matters, characteristics, aspects and advantages of the invention will become even more clearly apparent on reading the description and examples which follow.

In the present invention, unless expressly indicated otherwise, all the percentages (%) shown are % by weight.

Thermoplastic elastomeric composition is understood to mean a composition which softens under the action of heat, hardens on cooling and exhibits, at low temperature and in particular at ambient temperature, an ability to more or less rapidly resume a starting shape and original dimensions after application of a strain.

The elastomeric composition according to the invention is thermoplastic above ambient temperature, that is to say that it exhibits an ability to be shaped by processes conventionally used in plastics technology or in confectionery, such as extrusion, injection molding, molding, blow molding, calendering and rolling.

Pre-expansion thermoplastic elastomeric composition is understood to mean an elastomeric composition which is not yet expanded but which nevertheless comprises, within it, expanding agents which are not yet activated (that is to say, nonexpanded). This composition is generally used and sold in the form of granules of diverse sizes. The pre-expansion thermoplastic elastomeric composition is generally used for an extrusion or injection purpose.

This thermoplastic composition is intended to be heated in order to be melted and transformed, under the effect of the heat, into a final expanded product.

As indicated above, the pre-expansion thermoplastic elastomeric composition comprises at least 10% by weight, with respect to the total weight of the composition, of one or more multiblock elastomers comprising at least one soft block and at least one hard block.

“Soft” (or also “flexible” or “elastomer”) block is understood to mean a block which exhibits a glass transition temperature (Tg) of less than ambient temperature (25° C.), preferably of less than or equal to 10° C. and more preferably of less than 0° C.

“Hard” (or also “rigid” or “thermoplastic”) block is understood to mean a block consisting of polymerized monomers and having a glass transition temperature, or a melting point in the case of semicrystalline polymers, of greater than or equal to 80° C., preferably varying from 80° C. to 250° C., more preferably varying from 80° C. to 200° C. and in particular varying from 80° C. to 180° C.

Typically, each of these (hard or soft) segments or blocks contains at least more than 5, generally more than 10, base units (polymeric units).

In the present patent application, when reference is made to the glass transition temperature of an elastomer, it is the glass transition temperature relating to the soft block (or elastomer block) which is concerned (unless otherwise indicated). This is because, in a known way, multiblock elastomers comprising at least one soft block and at least one hard block exhibit two glass transition temperature (Tg, measured according to ASTM D3418) peaks, the lower temperature relating to the soft part of the elastomer and the higher temperature relating to the hard part of the elastomer.

Thus, the elastomer or elastomers which can be used according to the invention preferably exhibit a glass transition temperature (thus a glass transition temperature of the soft block) which is less than or equal to 25° C., more preferably less than or equal to 10° C.

Preferably again, the glass transition temperature of the elastomers which can be used according to the invention is greater than −130° C.

These elastomers exhibit, within their range, various molecular weights starting from low molecular weights to high molecular weights.

The elastomers which can be used according to the invention are preferably copolymers with a small number of blocks (less than 5, typically 2 or 3).

Preferably, the elastomer or elastomers are chosen from hard block/soft block/hard block triblock elastomers and hard block/soft block diblock elastomers, and more preferably are chosen from hard block/soft block/hard block triblock elastomers.

The soft block or blocks of the elastomer or elastomers which can be used according to the invention can be unsaturated soft blocks.

Unsaturated soft block is understood to mean that this block results, at least in part, from conjugated diene monomers.

The unsaturated soft blocks which can be used according to the invention are preferably chosen from any homopolymer of a monomer exhibiting conjugated dienes and any copolymer of a monomer exhibiting conjugated dienes with another monomer.

In particular, the unsaturated soft blocks which can be used according to the invention can be chosen from:

a) any homopolymer obtained by polymerization of a conjugated diene monomer having from 4 to 12 carbon atoms;

b) any copolymer obtained by copolymerization of one or more conjugated dienes with one another or with one or more vinylaromatic compounds having from 8 to 20 carbon atoms;

c) a ternary copolymer obtained by copolymerization of ethylene and of an α-olefin having from 3 to 6 carbon atoms with a nonconjugated diene monomer having from 6 to 12 carbon atoms, such as, for example, the elastomers obtained from ethylene and propylene with a nonconjugated diene monomer of the abovementioned type, such as, in particular, 1,4-hexadiene, ethylidenenorbornene or dicyclopentadiene;

d) a copolymer of isobutene and of isoprene (butyl diene rubber) and also the halogenated versions, in particular chlorinated or brominated versions, of this type of copolymer.

The following are suitable in particular as conjugated dienes: isoprene, 1,3-butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3 -pentadiene, 4-methyl-1,3 -pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene and a mixture of these conjugated dienes; preferably, these conjugated dienes are chosen from isoprene, butadiene and a mixture containing isoprene and/or butadiene.

It should be noted that reactive functionalities, such as maleic anhydride or glycidyl methacrylate, or other functionalities having the aim of a compatibilization or a chemical reactivity, can be grafted to this unsaturated soft block.

Particularly preferably in the invention, the soft block or blocks are chosen from the group consisting of polyisoprenes, polybutadienes, copolymers of butadiene and isoprene, copolymers of styrene and of butadiene, copolymers of ethylene and of butadiene, and the mixtures of these polymers, these polymers being nonhydrogenated or partially hydrogenated.

The soft block or blocks of the elastomer or elastomers which can be used according to the invention can also be saturated soft blocks.

Generally, these saturated soft blocks are obtained by hydrogenation of unsaturated soft blocks or by simple copolymerization.

As explained above, the elastomer or elastomers which can be used according to the invention also comprise at least one hard block. The hard block or blocks can be formed from polymerized monomers of various natures.

In particular, the hard block or blocks can be chosen from the group consisting of polyolefins (polyethylene, polypropylene), polyurethanes, polyamides, polyesters, polyacetals, polyethers (polyethylene oxide, polyphenylene ether), polyphenylene sulfides, polyfluorinated compounds, such as fluorinated ethylene/propylene (FEP), perfluoroalkoxy (PFA) and ethylene/tetrafluoroethylene (ETFE), polystyrenes, polycarbonates, polysulfones, polymethyl methacrylate, polyetherimide, thermoplastic copolymers, such as the acrylonitrile/butadiene/styrene (ABS) copolymer, and the mixtures of these polymers.

As regards the polystyrenes, these are obtained from styrene monomers.

Styrene monomer should be understood in the present description as meaning any monomer comprising styrene, both unsubstituted and substituted. Mention may be made, among substituted styrenes, for example, of methylstyrenes (for example o-methylstyrene, m-methylstyrene or p-methylstyrene, a-methylstyrene, α,2-dim ethyl styrene, a,4-dim ethyl styrene or diphenyl ethylene), para(tert-butyl)styrene, chlorostyrenes (for example o-chlorostyrene, m-chlorostyrene, p-chlorostyrene, 2,4-dichlorostyrene, 2,6-dichlorostyrene or 2,4,6-trichlorostyrene), bromostyrenes (for example o-bromostyrene, m-bromostyrene, p-bromostyrene, 2,4-dibromostyrene, 2,6-dibromostyrene or 2,4,6-tribromostyrene), fluorostyrenes (for example o-fluorostyrene, m-fluorostyrene, p-fluorostyrene, 2,4-difluorostyrene, 2,6-difluorostyrene or 2,4,6-trifluorostyrene) or also para-hydroxystyrene.

As can be done for the soft blocks, reactive monomers, or functionalities, can still be included, in a minor fashion, in the polymer chain of the hard block.

Mention may be made, as elastomers which can be used according to the invention, of multiblock copolymers of ethylene and of a-olefins, where the a-olefin is chosen from propylene, 1-butene, 1-hexene, 1-octene, 4-methyl-1-pentene, norbornene, 1-decene, 1,5-hexadiene, ethylene or a combination of such compounds.

These multiblock copolymers of ethylene and of a-olefins can comprise one or more hard segments comprising at least 98% by weight of ethylene and one or more soft segments comprising less than 95% by weight, preferably less than 50% by weight, of ethylene. Preferably, the hard segments are present in an amount of 5% to 85% by weight.

By way of example, these multiblock copolymers of ethylene and of α-olefins can be provided by Dow under the Engage and Infuse ranges.

The elastomer or elastomers which can be used according to the invention are preferably chosen from styrene/butadiene/styrene (SBS) polymers, styrene/isoprene/styrene (SIS) polymers, styrene/ethylene-butylene/styrene (SEBS) polymers, styrene/ethylene/propylene/styrene (SEP S) polymers, styrene/ethylene/ethylene-propylene/styrene (SEEPS) polymers, styrene/ethylene-butylene/styrene polymers comprising different units from the units resulting from ethylene and butylene in the ethylene-butylene block (SOESS from Asahi), styrene/ethylene-butylene/styrene polymers comprising functionalized units making possible crosslinking in the styrene block or blocks (Septon V from Kuraray), multiblock copolymers of ethylene and of a-olefins and the mixtures of these polymers, and preferably from styrene/ethylene-butylene/styrene polymers.

Preferably, the elastomer or elastomers which can be used according to the invention are chosen from elastomers comprising a saturated soft block; in particular, the elastomer which can be used according to the invention is the styrene/ethylene-butylene/styrene (SEBS) polymer.

Mention may in particular be made, as elastomer which can be used according to the invention, of the styrene/ethylene-butylene/styrene (SEBS) polymer comprising from 31% to 34% by weight of styrene units, with respect to the total weight of the polymer, sold under the name “Taipol 6151” by TSRC.

As indicated above, the elastomer or elastomers represent at least 10% by weight, with respect to the total weight of the elastomeric composition.

Preferably, the elastomer or elastomers represent from 10% to 40% by weight and more preferably from 15% to less than 40% by weight, more preferably from 15% to 37% by weight, better still from 15% to 35% by weight, with respect to the total weight of the elastomeric composition.

As indicated above, the pre-expansion elastomeric composition according to the invention comprises heat-expandable polymeric particles encapsulating a heat-expandable fluid.

Heat-expandable polymeric particles is understood to mean polymeric particles in the form of microspheres of polymers constituting the shell of the particle encapsulating a gas or a liquid with a diameter generally of approximately 10 μm.

These particles have the distinguishing feature, when they are heated, of having an internal pressure which increases due to the presence of the heated gas or of the boiling liquid. Thus, the size and the volume of the thermoplastic particles are increased until a maximum size of several tens of microns is achieved.

These particles have the advantage of making it possible to obtain an expanded thermoplastic elastomeric composition where the porosity of the composition is formed by virtue of these particles.

The polymers constituting the shell of the particles are generally chosen from polymers or copolymers of polyolefins, such as polyethylene and polystyrene, of polyamides, of polyesters, urea/formaldehyde polymers, acrylonitrile polymers, copolymers of acrylonitrile and of vinylidene chloride, and the mixtures of these polymers, and are preferably chosen from acrylonitrile polymers, copolymers of acrylonitrile and of vinylidene chloride, and the mixtures of these compounds.

Preferably, the heat-expandable polymeric particles which can be used according to the invention are chosen from particles which can expand from 140° C., preferably from 160° C.

The fluid encapsulated in the particles is a gas or a liquid, preferably a gas, such as a hydrocarbon, for example isobutane, pentane, isopentane, trimethylpentane or also a haloalkane.

Particularly preferably, the heat-expandable polymeric particles which can be used according to the invention are chosen from acrylonitrile particles including a hydrocarbon, such as isobutane, isopentane and haloalkanes.

Such heat-expandable polymeric particles are sold in particular under the “Expancel” commercial name by AkzoNobel.

Mention may also be made of the polymeric particles sold under the “Advancel” commercial name by Sekisui.

The pre-expansion thermoplastic elastomeric composition according to the invention advantageously comprises from 0.1% to 7% by weight, preferably from 0.5% to 2%, with respect to the total weight of the composition, of one or more heat-expandable polymeric particles.

The dosage of heat-expandable polymeric particles depends on the final density desired for the expanded material.

Advantageously, the pre-expansion thermoplastic elastomeric composition can additionally comprise one or more polyolefin thermoplastic polymers.

Preferably, the polyolefin thermoplastic polymer or polymers are chosen from homopolymers and copolymers of polyethylene, of polypropylene, functionalized polyolefins, such as polypropylene/maleic anhydride, and the mixtures of these polymers.

In a preferred form of the invention, the pre-expansion thermoplastic elastomeric composition comprises, in addition to the elastomer or elastomers and the heat-expandable polymeric particles, a homopolymer and/or copolymer of polypropylene and advantageously also a homopolymer and/or copolymer of polyethylene.

The pre-expansion thermoplastic elastomeric composition according to the invention advantageously comprises from 5% to 40% by weight, preferably from 10% to 35% by weight, with respect to the total weight of the composition, of one or more polyolefin thermoplastic polymers.

Advantageously, the pre-expansion elastomeric composition can also comprise one or more plasticizing agents, such as an oil (or plasticizing oil), or also a plasticizing polymer well known to a person skilled in the art, such as a polybutadiene or a polyisobutene.

Use may be made of any oil, preferably having a weakly polar nature, capable of extending or plasticizing elastomers, in particular thermoplastic elastomers. At ambient temperature (25° C.), these oils, which are more or less viscous, are liquids (that is to say, as a reminder, substances having the ability, in the long run, to assume the shape of their container), in contrast in particular to resins or rubbers, which are by nature solids. Use may also be made of any type of plasticizing resin known to a person skilled in the art.

For example, the extending oil is chosen from the group consisting of paraffinic oils.

Thus, in a specific form of the present invention, the pre-expansion thermoplastic elastomeric composition comprises one or more plasticizing oils, preferably one or more hydrocarbon oils and more preferably one or more paraffinic oils.

The pre-expansion thermoplastic elastomeric composition preferably comprises from 15% to 50% by weight, more preferably from 20% to 40% by weight, with respect to the total weight of the composition, of one or more plasticizing agents.

The pre-expansion thermoplastic elastomeric composition according to the invention can comprise fillers, such as calcium carbonate, talc, clays, silicas, carbon black, titanium dioxide, inorganic waste, such as, for example, recycled oyster shells, or industrial waste, such as, for example, recycled rubber.

A person skilled in the art can also add any type of filler known as such and not listed above.

The pre-expansion thermoplastic elastomeric composition according to the invention can also comprise various additives normally present in thermoplastic elastomeric compositions, in particular protective agents, such as antioxidants, antiozonants, and UV stabilizers and the various processing aids or other stabilizers.

The pre-expansion thermoplastic elastomeric composition according to the invention does not comprise any crosslinking agent, such as, for example, phenolic resin, peroxides or other crosslinking agents known to a person skilled in the art.

In a very particularly preferred form of the invention, the pre-expansion thermoplastic elastomeric composition comprises:

from 10% to 40% by weight, preferably from 15% to less than 40% by weight, more preferably from 15% to 37% by weight, better still from 15% to 35% by weight, of one or more elastomers chosen from styrene/butadiene/styrene (SBS) polymers, styrene/isoprene/styrene (SIS) polymers, styrene/ethylene-butylene/styrene (SEB S) polymers, styrene/ethylene/propylene/styrene (SEP S) polymers, styrene/ethylene/ethylene-propylene/styrene (SEEPS) polymers, styrene/ethylene-butylene/styrene polymers comprising different units from the units resulting from ethylene and butylene in the ethylene-butylene block (SOESS), styrene/ethylene-butylene/styrene polymers comprising functionalized units making possible crosslinking in the styrene block or blocks (Septon V), multiblock copolymers of ethylene and of a-olefins and the mixtures of these polymers, and preferably from styrene/ethylene-butylene/styrene (SEBS) polymers,

from 15% to 50% by weight, preferably from 20% to 40% by weight, of one or more paraffinic oils,

from 5% to 40% by weight, preferably from 10% to 35% by weight, of one or more polyolefin thermoplastic polymers, preferably chosen from homopolymers and/or copolymers of polyethylene, of polypropylene, and the mixtures of these polymers,

from 0.1% to 7% by weight, preferably from 0.5% to 2% by weight, of heat-expandable polymeric particles encapsulating a heat-expandable fluid,

the contents being given with respect to the total weight of the composition.

The pre-expansion thermoplastic elastomeric composition according to the invention is generally prepared by mixing the constituents and heating at a temperature which is less than the expansion temperature of the heat-expandable polymeric particles, preferably less than 160° C.

The pre-expansion thermoplastic elastomeric composition according to the invention is generally available in the form of beads or of granules.

Another subject matter of the present invention is a process for the preparation of an expanded thermoplastic elastomeric composition comprising the following stages:

injection into a mold or addition to an extruder die of the pre-expansion elastomeric composition as defined above, then

heating the composition at a temperature greater than the temperature for expansion of the heat-expandable polymeric particles, preferably of greater than 160° C.

Preferably, the stage of heating the pre-expansion elastomeric composition takes place at a temperature of greater than 180° C., more preferably at a temperature of greater than 190° C.

Another subject matter of the present invention is a noncrosslinked expanded thermoplastic elastomeric composition capable of being obtained by the above process.

Preferably, the expanded thermoplastic elastomeric composition is obtained by the process according to the invention.

The expanded thermoplastic elastomeric composition according to the invention comprises:

at least 10% by weight, with respect to the total weight of the composition, of one or more multiblock elastomers comprising at least one soft block and at least one hard block,

expanded polymeric particles,

the expanded elastomeric composition not being crosslinked.

The expanded thermoplastic elastomeric composition according to the invention can comprise one or more of the characteristics of the pre-expansion thermoplastic elastomeric composition as defined above.

The expanded thermoplastic elastomeric composition according to the invention generally exhibits a density of less than 1, preferably of less than 0.85.

The expanded thermoplastic elastomeric composition according to the invention exhibits a compression set of less than 65%, preferably of less than 55%, according to the standard ISO 815, method A, diagram B, 22 h at 70° C.

Finally, a subject matter of the present invention is a sealing lip which can be used in various fields requiring sealing properties, such as the industry of transportation, construction, electrical goods or even packaging.

Preferably, the sealing lip according to the invention is used in the fields of the transportation industry and in the construction industry and more particularly used in the field of sealing lips for the transportation industry.

The sealing lip according to the invention is, for example, intended to be used in any vehicle, preferably in motor vehicles of passenger vehicle or SUV (Sport Utility Vehicles) type, two-wheel vehicles (in particular motorcycles), aircraft, boats and also industrial vehicles, such as vans, heavy-duty vehicles and other transportation or handling vehicles.

The invention and also its advantages will be more deeply understood in the light of the implementational example which follows.

### EXAMPLE

Compositions according to the invention

The contents are shown as % by weight.

| Composition | A1 | A2 |
|---|---|---|
| Copolymer having linear SEBS blocks | 34 | 18 |
| comprising 32% by weight of styrene | | |
| units⁽¹⁾ | | |
| Paraffinic oil | 34 | 28 |
| Polypropylene⁽²⁾ | 20 | 4 |
| Medium-density polyethylene | 7 | 8.5 |
| (MFI = 0.1, d = 0.939) | | |
| Calcium carbonate (5 μm) | 3.65 | 35.15 |
| Phosphite | 0.35 | 0.35 |
| Heat-expandable polymeric microspheres⁽³⁾ | 1 | 1 |
| Polyphenylene ether⁽⁴⁾ | — | 5 |

⁽¹⁾Taipol 6151
⁽²⁾PP050G2M
⁽³⁾Expancel 980DU120
⁽⁴⁾PX-100F
MFI: melt flow index

The elastomeric composition A1 according to the invention is compared with a commercial composition B1 used for the sealing of motor vehicle windows. The compositions A1 and B1 exhibit an equivalent hardness.

| Characteristics and standards | | B1 (Comp.) | A1 (Inv.) |
|---|---|---|---|
| Hardness (Shore A) | ISO868 | 68 | 67 |
| | (15 s) | | |
| Relative density | ISO1183 | 1.13 | 0.69 |
| Stress at a strain of | ISO37 | 2.3 | 2.2 |
| 100% (in MPa) | 23° C. - H1 - | | |
| | 500 mm/min | | |
| Tensile strength (in | ISO37 | 6.1 | 4.7 |
| MPa) | 23° C. - H1 - | | |
| | 500 mm/min | | |
| Elongation at break (in | ISO37 | 470 | 540 |
| %) | 23° C. - H1 - | | |
| | 500 mm/min | | |
| Compression set | ISO815-1, A | 48 | 53 |
| (in %) | 22 h, 70° C. | | |
| Fogging test | DIN 75201-B, | 5.9 | 1.6 |
| (in mg) | 100° C. | | |

At equivalent hardness, the composition A1 according to the invention exhibits a lower relative density than the comparative composition B1, which reflects the expansion of the composition A1 according to the invention.

However, despite a lower density and an equivalent hardness, the composition A1 according to the invention exhibits similar elastomeric properties to the composition B1, in particular relating to the compression set, which remains low and in accordance with the requirements necessary in the motor vehicle field.

Furthermore, the fogging tests show that the composition A1 according to the invention exhibits a much lower emission of volatile organic compounds than the comparative composition B1.

The elastomeric composition A2 according to the invention is compared with a conventional commercial composition B2 used for the sealing of motor vehicle windows. The compositions A2 and B2 exhibit an identical hardness.

| Characteristics and standards | | B2 (Comp.) | A2 (Inv.) |
|---|---|---|---|
| Hardness (Shore A) | ISO868 | 45 | 45 |
| | (15 s) | | |
| Relative density | ISO1183 | 1 | 0.75 |
| Stress at a strain of | ISO37 | 1.2 | 1.5 |
| 100% (in MPa) | 23° C. - H1 - | | |
| | 500 mm/min | | |
| Tensile strength (in | ISO37 | 3.3 | 2.9 |
| MPa) | 23° C. - H1 - | | |
| | 500 mm/min | | |
| Elongation at break | ISO37 | 650 | 351 |
| (in %) | 23° C. - H1 - | | |
| | 500 mm/min | | |
| Compression set | ISO815-1, A | 43 | 47 |
| (in %) | 22 h, 70° C. | | |
| Fogging test | DIN 75201-B, | 2.9 | 1.2 |
| (in mg) | 100° C. | | |

At identical hardness, the composition A2 according to the invention exhibits a lower relative density than the comparative composition B2, which reflects the expansion of the composition A2 according to the invention.

However, despite a lower density and an identical hardness, the composition A2 according to the invention exhibits similar elastomeric properties to the composition B2, in particular relating to the compression set, which remains low and in accordance with the requirements necessary in the motor vehicle field. Furthermore, the fogging tests show that the composition A2 according to the invention exhibits a much lower emission of volatile organic compounds than the comparative composition B2.

1. Noncrosslinked pre-expansion thermoplastic elastomeric composition, comprising:
at least 10% by weight, with respect to the total weight of the composition, of one or more multiblock elastomers comprising at least one soft block and at least one hard block,
heat-expandable polymeric particles encapsulating a heat-expandable fluid.

2. Thermoplastic elastomeric composition according to claim 1, characterized in that the elastomer or elastomers are chosen from hard block/soft block diblock elastomers, hard block/soft block/hard block triblock elastomers and preferably from hard block/soft block/hard block triblock elastomers.

3. Thermoplastic elastomeric composition according to claim 1, characterized in that the elastomer or elastomers are chosen from styrene/butadiene/styrene (SBS) polymers, styrene/isoprene/styrene (SIS) polymers, styrene/ethylene-butylene/styrene (SEBS) polymers, styrene/ethylene/propylene/styrene (SEPS) polymers, styrene/ethylene/ethylene-propylene/styrene (SEEPS) polymers, styrene/ethylene-butylene/styrene polymers comprising different units from the units resulting from ethylene and butylene in the ethylene-butylene block (SOESS), styrene/ethylene-butylene/styrene polymers comprising functionalized units making possible crosslinking in the styrene block or blocks, multiblock copolymers of ethylene and of α-olefins and the mixtures of these polymers, and preferably from styrene/ethylene-butylene/styrene (SEB S) polymers.

4. Thermoplastic elastomeric composition according to claim 1, characterized in that the elastomer or elastomers represent from 10% to 40% by weight, preferably from 15% to less than 40% by weight, more preferably from 15% to 37% by weight, better still from 15% to 35% by weight, with respect to the total weight of the elastomeric composition.

5. Thermoplastic elastomeric composition according to claim 1, characterized in that the heat-expandable polymeric particles are chosen from particles which can expand from 140° C., preferably from 160° C.

6. Thermoplastic elastomeric composition according to claim 1, characterized in that the heat-expandable polymeric particles are chosen from acrylonitrile particles including a hydrocarbon, such as isobutane, isopentane and haloalkanes.

7. Thermoplastic elastomeric composition according to claim 1, characterized in that it comprises from 0.1% to 7% by weight, preferably from 0.5% to 2%, with respect to the total weight of the composition, of one or more heat-expandable polymeric particles.

8. Thermoplastic elastomeric composition according to claim 1, characterized in that it additionally comprises one or more polyolefin thermoplastic polymers, preferably chosen from homopolymers and copolymers of polyethylene, of polypropylene, functionalized polyolefins, and the mixtures of these polymers.

9. Thermoplastic elastomeric composition according to claim 1, characterized in that it comprises a homopolymer and/or copolymer of polypropylene and advantageously also a homopolymer and/or copolymer of polyethylene.

10. Thermoplastic elastomeric composition according to claim 1, characterized in that it comprises one or more plasticizing agents, preferably one or more plasticizing oils, more preferably one or more hydrocarbon oils, in particular one or more paraffinic oils.

11. Thermoplastic elastomeric composition according to claim 1, characterized in that it comprises:
from 10% to 40% by weight, preferably from 15% to less than 40% by weight, more preferably from 15% to 37% by weight, better still from 15% to 35% by weight, of one or more elastomers chosen from styrene/butadiene/styrene (SBS) polymers, styrene/isoprene/styrene (SIS) polymers, styrene/ethylene-butylene/styrene (SEBS) polymers, styrene/ethylene/propylene/styrene (SEPS) polymers, styrene/ethylene/ethylene-propylene/styrene (SEEPS) polymers, styrene/ethylene-butylene/styrene polymers comprising different units from the units resulting from ethylene and butylene in the ethylene-butylene block (SOESS), styrene/ethylene-butylene/styrene polymers comprising functionalized units making possible crosslinking in the styrene block or blocks, multiblock copolymers of ethylene and of α-olefins and the mixtures of these polymers, and preferably from styrene/ethylene-butylene/styrene (SEBS) polymers,
from 15% to 50% by weight, preferably from 20% to 40% by weight, of one or more paraffinic oils,
from 5% to 40% by weight, preferably from 10% to 35% by weight, of one or more polyolefin thermoplastic polymers, preferably chosen from homopolymers and/or copolymers of polyethylene, of polypropylene, and the mixtures of these polymers,
from 0.1% to 7% by weight, preferably from 0.5% to 2% by weight, of heat-expandable polymeric particles encapsulating a heat-expandable fluid,
the contents being given with respect to the total weight of the composition.

12. Process for the preparation of an expanded thermoplastic elastomeric composition comprising the following stages:
injection into a mold or addition to an extruder die of the pre-expansion thermoplastic elastomeric composition according to any one of the preceding claims, then
heating the pre-expansion thermoplastic elastomeric composition at a temperature greater than the temperature for expansion of the heat-expandable polymeric particles, preferably of greater than 160° C.

13. Noncrosslinked expanded thermoplastic elastomeric composition capable of being obtained by the process according to claim 12.

14. Sealing lip used in the fields of the transportation industry and in the construction industry, comprising the expanded thermoplastic elastomeric composition according to claim 13.
